(19) United States
(12) Patent Application Publication
(10) Pub. No.: US 2003/0191762 A1
(43) Pub. Date: Oct. 9, 2003

(54) Group management

(76) Inventors: Juha Kalliokulju, Vesilahti (FI); Matti Turunen, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/118,656

(22) Filed: Apr. 8, 2002

(51) Int. Cl. G06F 17/00

(52) U.S. Cl. 707/100

(57) ABSTRACT

A data structure including specific services such as presence, messaging or the like, and including a group management service, as well as a device and a system using this data structure, is modified to provide specific services within the group management service rather than necessarily as separate services, thereby eliminating the need to invoke both the specific service and group management and to reduce signaling.

### BACKGROUND OF THE INVENTION

1. Technical Field

The present invention relates to Group Management, and, more particularly, to an enhancement for group management functionality which enables more effective use of group management in the context of services.

2. Discussion of Related Art

Currently, group management requirements specify the management function to be generic across all types of services and do not contain any (group) service-specific requirements. In that form, the group management function requires additional service management procedures for a given service that describes how the groups are utilized within the given service. This leads to additional complexity and increases the signaling load. On the other hand, if an attempt is made to specify group services instead of group management, the task would be practically difficult, because the requirements for different services will vary, and it is hard to foresee all the possibilities today.

For instance, assume a chat service. An “owner” of a chat group wants to create a system which allows persons A and B to see all the messages sent but not able to post anything. Persons C, D and E would have ‘full’ rights, i.e., they would be able to see the discussion and send messages to contribute to the discussion.

The current state-of-the-art in group management would create groups XX (containing A and B) and YY (containing C, D and E). In addition to that, there would be a need to specify service-specific commands where the properties/rights of these groups would be described. E.g., GROUP_ROLES_MESSAGE (group XX: reading rights only, group YY reading and writing rights). Taking this approach it would be rather difficult to create new services to the all-IP network without any further standardization.

Another form would take the same case as above but we would loosen the definition of the current group management would be loosened so that it would take into account the described case above. After such the ‘group management’ would need to take into account all possible services and finalization of it in standardization would be difficult or it would not be future-proof.

### DISCLOSURE OF INVENTION

An object of the present invention is to provide a mechanism to enable more effective use of group management in the context of different services.

According to a first aspect of the present invention, a data structure including a plurality of primitives each for carrying out a separate function of a group management service, each primitive for at least temporary storage in a computer-readable medium at a client and in a computer readable medium at a server during transfer of said primitives over a network between the client and the server, each primitive including at least one information element having information relating to said separate function, each primitive having an identifying information element with information identifying said separate function of said group management service, is characterized in that at least one primitive of said plurality of primitive also contains an information element or is associated with a header or field relating to a service-specific function and that said service-specific function is subsumed within said group management service.

In further accord with the present invention, the data structure is characterized in that the service-specific function relates to a presence service and the data structure includes a presence information element, header, or field provided from a client to the server within said group management function.

In still further accord with the present invention, the data structure is characterized in that the service-specific function relates to a rich call service and the data structure includes a rich call information element, header, or field provided from a client to the server within said group management function.

Further in accord with the present invention, the data structure is characterized in that the service-specific function relates to a messaging service and the data structure includes a message information element, header, or field provided from a client to the server within said group management function.

Still further in accord with the present invention, the data structure is characterized in that the service-specific function relates to a content management service and the data structure includes a content management information element, header, or field provided from a client to the server within said group management function.

According still further with the present invention, the data structure is characterized in that associated with the plurality of primitives are group access privileges.

Further still in accord with the present invention, the data structure is characterized in that said separate function of said group management service is a create group function, a delete group function, a modify group function, a group information function, a subscribe presence function, an unsubscribe presence function, or a presence request function.

In accord still further with the present invention, the data structure is characterized in that upon receipt of one of said plurality of primitives for carrying out said separate function of said group management service, said primitive including said information element, header, or field relating to said service-specific function, if said client or server receiving said primitive does not recognize said information element, header, or field, an error message is not necessarily generated.

According to a second aspect of the present invention, a device having means for at least temporarily storing a data structure for transmission or reception, is characterized in that said data structure is according to the first aspect of the present invention.

According to a third aspect of the present invention, a system having at least one server able to communicate with a plurality of devices, wherein a communication protocol is used between the at least one server and the plurality of devices is characterized by a data structure according to the first aspect of the present invention.

According to a fourth aspect of the present invention, a service-specific information element, header, or extension field is added to group management and is linked to individual members as well as the whole group. If an entity that receives a group command e.g. a server does not understand the extension, it is ignored without an error indication.

The invention proposes to organize group management so that both the group and the individual members in the group would have an extendable, generic field, header or the like that is able to carry service-specific information. Multiple fields or headers could be used to the same effect. This header or field would carry an identification for which service the further instructions are applied and what are the instructions. If the server does not understand the service ID the field is ignored without any errors being generated. E.g., in case of Instant Messaging (IM) the field could be used as described: user A wants to block all the messages from B and C. A creates a group XX (containing B and C) with a ‘group property’ IM service, block list. Another example would be the one described above: user would create one group ZZZ where A, B, C, D and E are the members. After each member there would be one or more service specific fields A (read); B (read); C (read/write); D (read/write) and E (read/write). Yet another example would be a presence authorisation. The field would carry information that it is intended for a presence service. The group management command would list all the members of the group and the presence service specific field would contain all the identifiers of the tuples that these persons would be able to see/subscribe.

These and other objects, features and advantages of the present invention will become more apparent in light of the following detailed description of a best mode embodiment thereof, as illustrated in the accompanying drawing.

### BRIEF DESCRIPTION OF THE DRAWING

FIG. 1 shows a system in which the group management of the present invention may be employed.

FIG. 2 shows a protocol structure used in the clients and servers of FIG. 1.

FIG. 3 shows more details of the service capabilities layer of FIG. 2 in both the client and server and particularly shows how user group management requirements are currently specified to be generic across all types of services.

FIG. 4 shows a set of primitives being exchanged between a client and server and defining some capabilities of a group management function.

FIG. 5 shows information elements being assembled by a service capabilities layer into a primitive or vice versa from a primitive into individual information elements and also shows a header, according to the present invention.

FIG. 6 shows a primitive, according to the present invention, with a header such as shown in FIG. 5, although it should be realized that this invention can also be assembled to be part of the payload even if the header is the more preferred implementation option.

FIG. 7 shows the header of FIGS. 5 and 6 in more detail; it can contain information for multiple services or there can be several headers each of which contains information specific to one service only.

FIG. 8 shows a plurality of primitives which may be exchanged between a server and clients according to the presence service capabilities component 36c of FIG. 3.

FIG. 9 shows a plurality of primitives which may be exchanged between a server and clients according to the messaging service capabilities component 36a of FIG. 3.

### BEST MODE FOR CARRYING OUT THE INVENTION

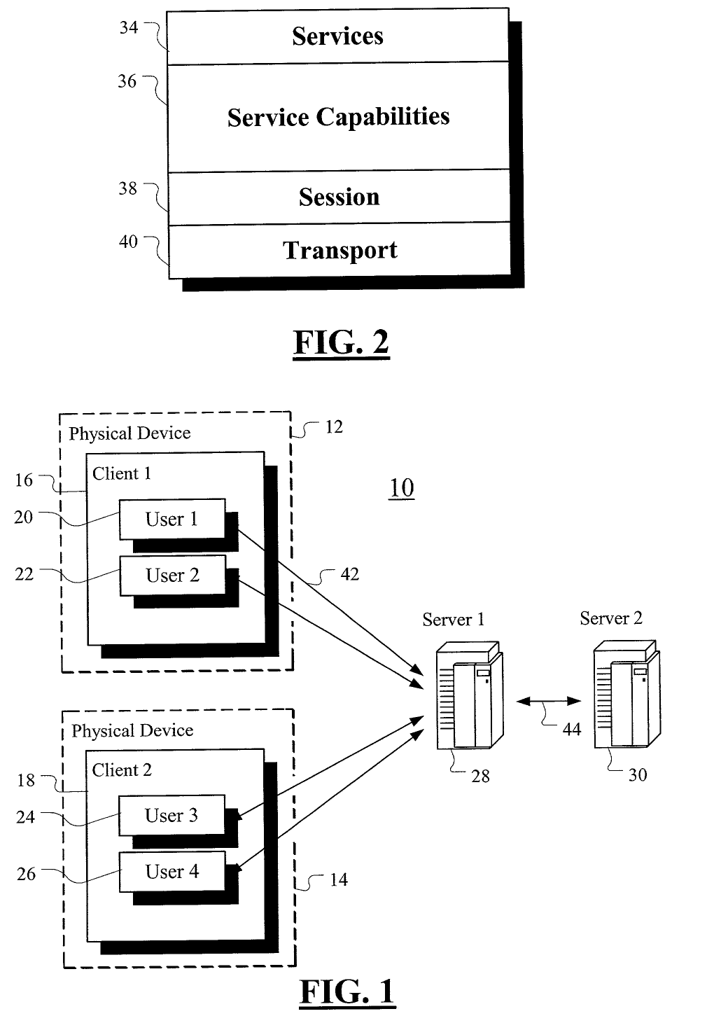

FIG. 1 shows a system 10 comprising physical devices 12, 14, clients 16, 18, users 20, 22, 24, 26, and servers 28, 30. A user is a customer of the system, enjoying services thereof provided by using the physical devices 12, 14. A client is an implementation of a given service which allows one or more users to access the service. The client may be hardware, software, firmware, or any combination thereof. The client concept is device independent, but for purposes of actual use it is installed in a physical device. Although not shown, more than one client can be resident on a given physical device, and the same user can access different clients on the same device. For instance, a not shown client 3 could be installed on device 14 and accessed by user 3. A server is a network element providing the services and maintaining user data. The servers may be interconnected.

A user may access the server simultaneously from several clients (using a single device or multiple devices). Similarly, a client may provide simultaneous access for several users.

When a physical device, e.g., mobile handset or PC, has multiple client instances, they may need to be separately identifiable. But for many cases, the device identity and the client identity can be considered the same. In those cases, for all intents and purposes, the physical device is therefore the same as the client.

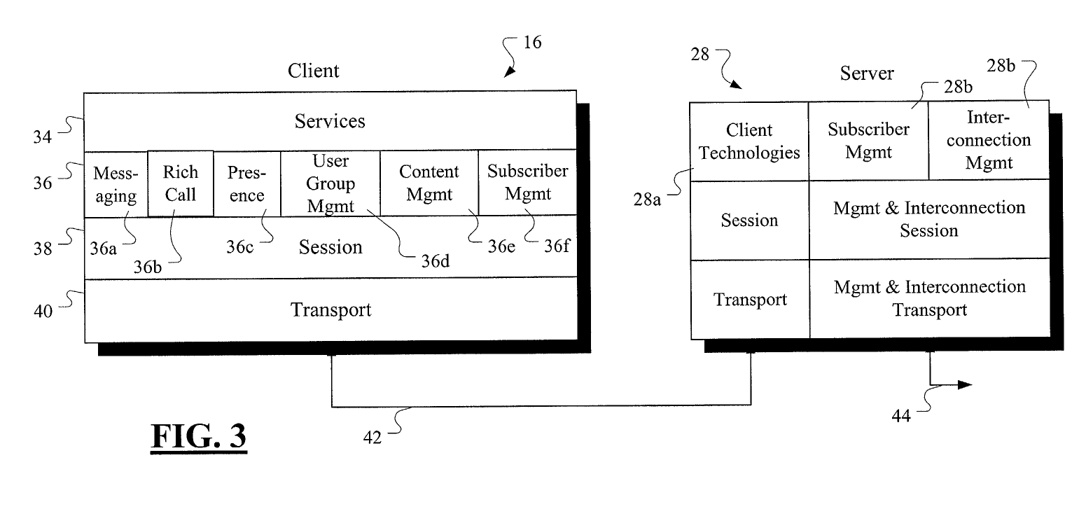

Both the clients and the servers of FIG. 1 will have a layered approach such as shown in FIG. 2 for facilitating the provision of services. But the servers intermediate the client will not usually utilize the topmost layer, i.e., a services layer 34. The model shown in FIG. 2 includes also a service capabilities layer 36, a session layer 38 and a transport layer 40. The services layer 34 includes services such as messaging (chat, dating, meeting, conferencing, etc.), presence, rich call, etc. The next lower service capabilities layer 36 includes a high-level protocol description including primitives with information elements and message flows. The service capabilities layer 12 defines the information elements in the abstract messages. It also suggests the technologies that may be selected in this level (such as encoding of information elements). The various services of the service layer 34 will be able to use the service capabilities layer 36 as a toolbox to create the various services.

An exemplary division of service capabilities is shown in FIG. 3. The next lower session layer 38 includes mapping of the service capabilities through existing sessions, such as MMS (Multimedia Message Service), SIP (Session Initiation Protocol), SMS (Short Message Service), and USSD (Unstructured Supplementary Data). The bottom transport layer 40 includes definitions of how to use transports: TCP/UDP/IP (Transport Control Protocol/User Datagram Protocol/Internet Protocol), SMS/USSD as bearer, WAP/WSP (Wireless Application Protocol/Wireless Session Protocol). The illustration of FIG. 3 shows all these various layers at both the client and server, except for the topmost services layer not being present at the server, as mentioned above.

A client having the layered structure of FIG. 3 will communicate over a communication link 42 with a server having a similar layered structure, except not having the topmost services layer. The server will, in turn, communicate ultimately with other clients either directly or through other services, and those clients will have service layers in the same way the client of FIG. 3 has such a service layer. As mentioned, the services layer includes services such as messaging, presence, rich call, etc.

Focusing on the service capabilities layer 36, this layer may include various components, as shown. One of these, for instance, may be a messaging component 36a, wherein the exchange of instant messages is provided for. Similarly, a rich call component 36b may be provided. A presence component 36c may be provided for as well. User group management 36d involves management of various aspects of the other services, including messaging, rich call and presence, etc. Content management 36e provides for management of shared content, such as images and documents. Subscriber management 36f is also provided for. The same components 36a, 36b, 36c, 36d, 36e are shown condensed on the server 27 side of FIG. 3 as client technologies 28a, whereas a subscriber management component 28b is shown by itself, along with an interconnection management component 28c.

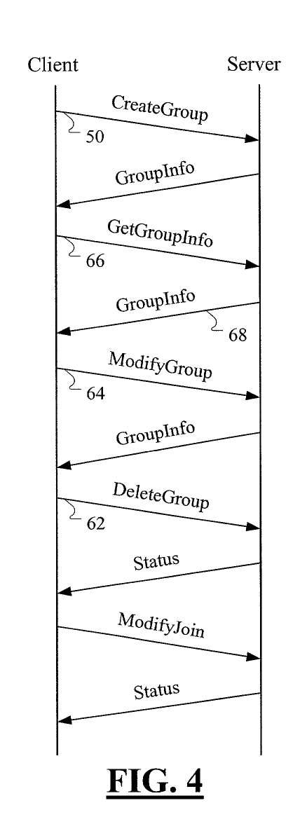

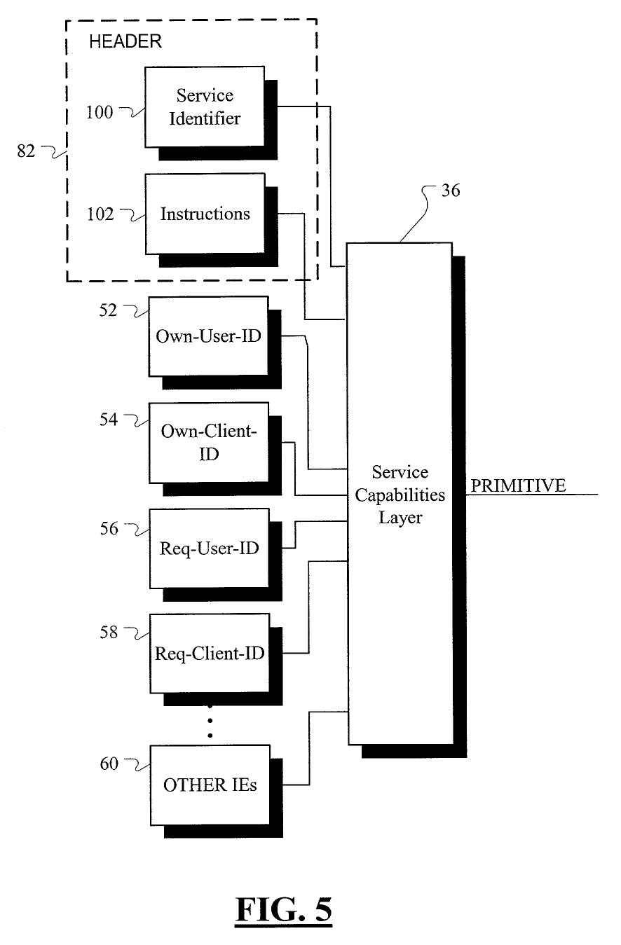

Each of the components of the service capabilities layer 36 will have a defined set of primitives that are interchanged between a client and a server that together define the service capability component. For instance, as shown in FIG. 4, the user group management component 36d may include a plurality of primitives such as shown. Each of these primitives should most likely be mandatory but are not necessarily so. A CreateGroup primitive is provided on a line 50 from the client to the server and includes a plurality of information elements relating to the function of creating a group as per a particular client request to a server. These information elements for the Create Group primitive may, for instance, include a message identifier, a version of the specification, a transaction identifier, a client identifier, a user identifier, a list of requested properties of the group, a list of initial users for membership in the group being created, and a group name. It should be mandatory to name the group when creating it. The group name is not necessarily unambiguous however, i.e., it cannot be used for referring to the group (instead, a group ID, e.g. URL must be used). The group ID must be associated with the group while creating or uniquely identifying the group (this can happen so that the user proposes something and the server accepts it if it is alright. If it is not all right i.e. not unique, the server should propose something almost similar but modified a little to make it unique). FIG. 5 shows a plurality of such information elements 52, 54, 56, 58 . . . 60 being assembled and provided to the service capabilities layer 36 for assembly into a primitive such as the primitive 50 of FIG. 4. Other primitives which may be used for creating a group management function will now be discussed.

It should be possible to define group visibility with an appropriate information element when creating the group. It should also be possible to delete a group as provided in FIG. 4 with a DeleteGroup primitive on a line 62. Likewise, it should be possible to add one or more members to a group or take one or more members off a group as per a ModifyGroup primitive on a line 64. A GetGroupInfo primitive on a line 66 is provided from the client to the server and the server responds with a GroupInfo primitive on a line 68 indicative of for instance the group members or a list of groups where the user is a group member.

It should also be possible to modify group properties such as the group name, group visibility using for instance the ModifyGroup primitive on the line 64. It should also be possible to modify group member access rights using the ModifyGroup primitive or some similar primitive with appropriate information elements defined. Other requirements may be made such as shown in Table I, for instance. The group concept is flexible but should at least include the name of the group, the identification of the group, and group visibility which defines at least one of the users (person having user access privilege) who can get the group member list. The terminology used can be defined as follows:

Group—a group of persons which is used in group communication services such as Rich Call, Presence and Messaging, etc. Group can consist of number of persons or number of groups or combination of them.

Group management—a collection of operations how the group owner or moderator can e.g. create, delete and modify groups, including group properties.

Group member—a person belonging to a group.

Group owner=Group creator=Administrator—a person who has created the group and has administrator privileges for the group. Is may also be a group member.

Group properties—group properties such as group name, group ID, group visibility.

Group (related) service—a service utilizing groups which are managed by group management.

Group visibility—group visibility is a group property that defines who sees the group.

Moderator—a person who has moderator privileges for the group and is also a group member.

TABLE I

| Name | Requirement |
|---|---|
| Creation of a | It MUST be possible to create a group |
| group | |
| Group name | The group MUST be named when |
| | creating it. Group name is not necessarily |
| | unambiguous, i.e. it cannot be used for |
| | referring to the group (Group URL MUST |
| | be used) |
| Group URL | An URL MUST be associated with the |
| | group when creating it. Group URL |
| | identifies uniquely the group |
| Group | It MUST be possible to give a list of |
| members | group members when creating the group |
| Group visibility | It MUST be possible to define group |
| | visibility when creating the group |
| Deletion of a | It MUST be possible to delete a group |
| group | |
| Addition of a | It MUST be possible to add a member to |
| group member | an existing group |
| to a group | |
| Get group | It MUST be possible to get list of all |
| members | group member(s) from a group. |
| Removal of a | It MUST be possible to remove |
| group member | member(s) from a group. Group can |
| from a group | consist of group(s) so it must be possible |
| | to remove group(s) from a group. |
| Getting group | It MUST be possible to get group |
| properties | properties |
| Getting list of | It MUST be possible to get information |
| groups | about all groups where the user is a group |
| | member |
| Modification of | It MUST be possible to modify group |
| group properties | properties (group name, group URL, |
| | group visibility) |
| Modification of | It MUST be possible to modify group |
| group member | member access rights |
| access rights | |
| Notification of | It MUST be possible to get notifications |
| group properties | when group properties change |
| changes (multiple) | |
| terminal ownership | |
| or possibly | |
| multiple editors) | |
| Notification of | It MUST be possible to get notifications |
| group members | when group members change |
| change (multiple | |
| terminal ownership | |
| or possibly | |
| multiple editors) | |
| Group | There MUST be well defined group |
| management | management protocol between terminal |
| protocol | and network (i.e. group management |
| | through web pages is not enough) |

Associated with the group properties are access privileges.

There are three levels of access privileges to the groups

Administrator

Moderator

User

Administrators can do anything in a group. The creator of the particular group has always administrator privileges (administrator privileges cannot be removed) as long as the group exists. There is only one Administrator per group.

Moderators can add/remove members, but only ordinary users not moderators or administrators. There can be several Moderators per group.

Persons that do not have any administrative privileges but are group members are having User role. Group as a group member has only User privileges.

A person can get information only about those groups where the person is a group member (having Administrator, Moderator or User privileges).

The following Table II describes the availability of transactions for each privilege level, where Y=available, N=not available:

TABLE II

| Name | Administrators | Moderators | Users |
|---|---|---|---|
| Create group | N/A | N/A | N/A |
| Delete group | Y | N | N |
| Get group members | Y | Y | Y/N |
| | | | (depends on |
| | | | Group visibility) |
| Add group members | Y | Y | N |
| Remove group | Y | Y | N |
| members | | | |
| Get group properties | Y | Y | Y |
| (URL is known) | | | (but Users do not |
| | | | get visibility |
| | | | value) |
| Set group properties | Y | N | N |
| (URL is known) | | | |
| Get all groups (group | Y | Y | Y |
| names and IDs of all | | | |
| the groups where the | | | |
| person is a group | | | |
| member) | | | |
| Subscribe group | Y | Y | Y |
| change | | | |
| Group change | Y | Y | Y |
| notification | | | |
| Modify member | Y | N | N |
| access privileges | | | |

In addition to the user group management component of the service capabilities layer 36 of FIGS. 2 and 3, the other components 36a, 36b, 36c, 36e and 36f also have a group of primitives defined with each primitive having its own set of predefined information elements for assembly such as shown in FIG. 5. It will therefore be realized that these other components 36a, 36b, 36c, 36e, and 36f require a good deal of signaling between the client and the server because of their status as separate components of the service capabilities layer 36. This is what is meant by the statement in the Background of Invention section that the current group management function is specified as being generic across all types of services without containing any (group) service-specific requirements. In this form, the group management function is utilized along with one or more of the other service capability layer components such as presence or messaging, each of which may be associated with their own particular user groups.

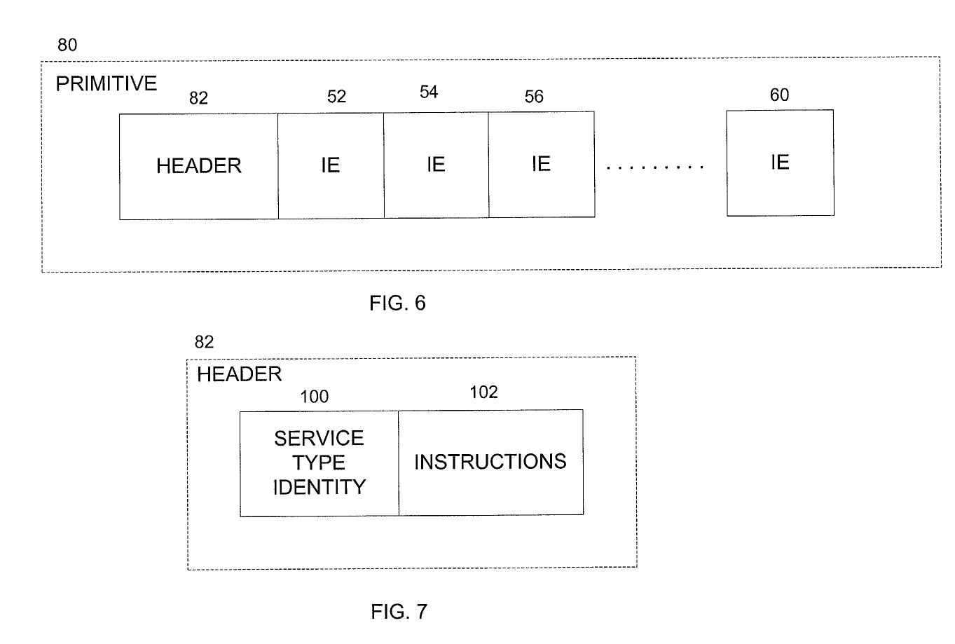

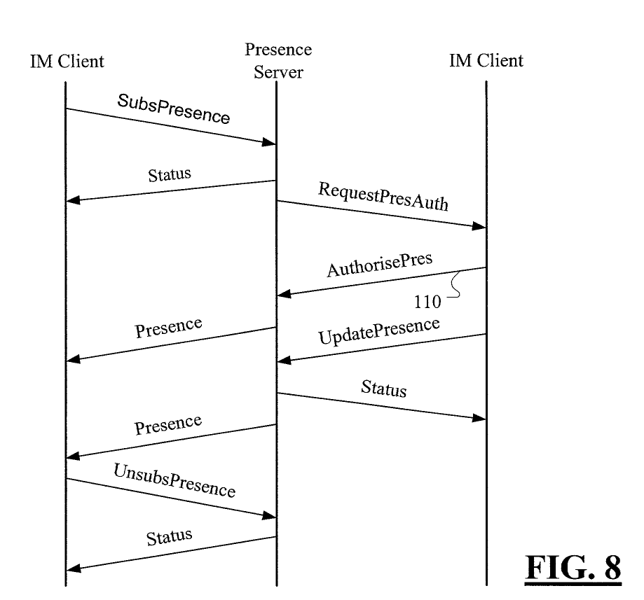

According to the present invention, the signaling load required by this approach is ameliorated by inserting service-specific functions into the signaling primitives defined for the group management component. For instance, as shown in FIG. 6, a group management primitive 80 is provided with a header 82 and a plurality of defined information elements 52, 54, 56 . . . 60. This might be part of a CreateGroup primitive defined for the User Group Management component 36d of FIG. 3, for instance. In addition to the information elements shown in FIG. 6, the header 82 may include a service-specific type identity 100 and instructions 102 as shown in FIG. 7. The recipient of the group management primitive 80 would then be able to determine the service-specific function identity from the header (with instructions). Alternatively, this could be done from one or more conditional or optional service-specific information elements. FIG. 5 shows how a header 82 with service identifier 100 and instructions 102 can be assembled along with the information elements 52, 54, 56, 58, . . . 60 in the service capabilities layer 36 in a manner similar as described above. In this way, the generic user group management component 36d of FIG. 3 can be used to convey service-specific information as well and signaling between the client and server is thereby reduced. This does not necessarily mean that the respective service-specific components 36a, 36b, 36c, 36e and 36f can be eliminated. They can coexist.

As suggested above, simply adding service-specific information elements to the primitives of the various group management primitives can be done instead of using a header approach.

FIG. 8 illustrates some presence primitives exchanged between a server and clients as part of the presence component 36c of FIG. 3. Each primitive has a standard set of associated mandatory, conditional, and optional information elements (IEs). Table III below illustrates such a set of IEs for the AuthorizePres primitive 110 of FIG. 8.

TABLE III
Authorize Presence

| Information Element | Req | Description |
|---|---|---|
| Message-Type | Mandatory | Message identifier |
| Version | Mandatory | Version of the IM specification |
| Transaction-ID | Mandatory | Identifies the authorisation request |
| | | transaction, either originated from |
| | | IM server or IM client |
| Own-User-ID | Mandatory | The identification of the requesting |
| | | IM user |
| Group-ID | Optional | Identifies the group if authorisation |
| | | of presence is related to group. |
| Presence-Value-List | Mandatory | A list of presence values requested. |

Some of these IEs can be added, in the category of optional or conditional, to group management primitives. For instance, one or more IEs of the AuthorizePres primitive could be used with the CreateGroup primitive 50 of FIG. 4 to create a group, such additional presence information elements would enable the creation of a group with some presence-specific service capabilities.

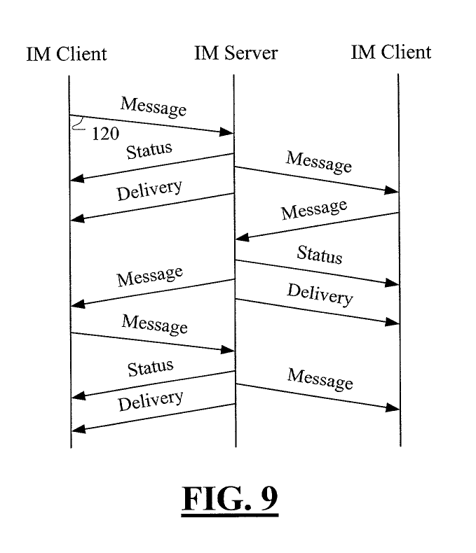

Another example is taken from the messaging component 36a of the service capabilities layer of FIG. 3 as shown in FIG. 9. Table IV below shows a standard set of IEs associated with a Message primitive 120.

TABLE IV
Message

| Information Element | Req | Description |
|---|---|---|
| Message-Type | Mandatory | Message identifier |
| Version | Mandatory | Version of the IM specification |
| Own-Client-ID | Mandatory | The identification of the sending IM |
| | | client. |
| Own-User-ID | Mandatory | The subscriber identification of the |
| | | sending IM user |
| Req-Client-ID | Conditional | The identification of the recipient IM |
| | | client, if message is targeted to |
| | | single IM client only. |
| Req-User-ID | Conditional | The subscriber identification of the |
| | | recipient IM user if individual |
| | | messaging is requested |
| Group-ID | Conditional | Identifies the group if messaging is |
| | | requested via buddy list |
| Join-ID | Conditional | Dynamic identification of the join |
| | | session. Present if messaging is |
| | | requested via public or private user |
| | | group. |
| Content-Type | Mandatory | The content type of the instant |
| | | message |
| Content | Optional | The content of the instant message |

From the IEs shown in Table IV, one or more IEs can be added to selected Group Management Primitives as standard optional or conditional IEs. For instance, the Content-Type and Content IEs can be added to one or more of the User Group Management 36d primitives. Likewise, the various group management functions carried out by the primitives of FIG. 4 can be augmented to carry out messaging functions, depending on which function is desired or appropriate for association therewith.

It is also possible to include functions e.g. by adding information elements from different services such as presence and messaging into a group management service function. It should be realized that although it has been shown above that various functions of formerly separate services can be subsumed within a group management service in order to reduce signaling, it is still possible to maintain these separate services as they are and only using the technique of the present invention where appropriate. In this way a more flexible system can be developed where either or both approaches can be used.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

What is claimed is:

1. A data structure including a plurality of primitives each for carrying out a separate function of a group management service, each primitive for at least temporary storage in a computer-readable medium at a client and in a computer readable medium at a server during transfer of said primitives over a network between the client and the server, each primitive (80) including at least one information element (52, 54, 56, . . . 60) having information relating to said separate function, each primitive having an identifying information element with information identifying said separate function of said group management service, characterized in that at least one primitive of said plurality of primitive also contains an information element or is associated with a header (82) or field relating to a service-specific function and that said service-specific function is subsumed within said group management service.

2. The data structure of claim 1, characterized in that the service-specific function relates to a presence service and
the data structure includes a presence information element, header, or field provided from a client to the server within said group management function.

3. The data structure of claim 1, characterized in that the service-specific function relates to a rich call service and
the data structure includes a rich call information element, header, or field provided from a client to the server within said group management function.

4. The data structure of claim 1, characterized in that the service-specific function relates to a messaging service and
the data structure includes a message information element, header, or field provided from a client to the server within said group management function.

5. The data structure of claim 1, characterized in that the service-specific function relates to a content management service and
the data structure includes a content management information element, header, or field provided from a client to the server within said group management function.

6. The data structure of claim 1, characterized in that associated with the plurality of primitives are group access privileges.

7. The data structure of claim 1, characterized in that said separate function of said group management service is a create group function.

8. The data structure of claim 1, characterized in that said separate function of said group management service is a delete group function.

9. The data structure of claim 1, characterized in that said separate function of said group management service is a modify group function.

10. The data structure of claim 1, characterized in that said separate function of said group management service is a group information function.

11. The data structure of claim 2, characterized in that said presence information element, header, or field relates to a subscribe presence function.

12. The data structure of claim 2, characterized in that said presence information element, header, or field relates to an unsubscribe presence function.

13. The data structure of claim 2, characterized in that said presence information element, header, or field relates to a presence request function.

14. The data structure of claim 1, characterized in that upon receipt of one of said plurality of primitives for carrying out said separate function of said group management service, said primitive including said information element, header, or field relating to said service-specific function, if said client or server receiving said primitive does not recognize said information element, header, or field, an error message is not necessarily generated.

15. A device having means for at least temporarily storing a data structure for transmission or reception, characterized in that said data structure is according to claim 1.

16. A system having at least one server able to communicate with a plurality of devices, wherein a communication protocol is used between the at least one server and the plurality of devices with a data structure according to claim 1.
